(19) United States
(12) Patent Application Publication
(10) Pub. No.: US 2006/0013216 A1
(43) Pub. Date: Jan. 19, 2006

(54) Apparatus and method for supporting real-time services in a wireless network

(75) Inventors: Purva R. Rajkotia, Plano, TX (US); William J. Semper, Richardson, TX (US); John C. Jubin, Richardson, TX (US)

Correspondence Address: DOCKET CLERK, P.O. DRAWER 800889, DALLAS, TX, 75380, US

(73) Assignee: SAMSUNG ELECTRONICS CO., LTD., Suwon-city (KR)

(21) Appl. No.: 11/126,438

(22) Filed: May 11, 2005

Related U.S. Application Data
(60) Provisional application No. 60/587,620, filed on Jul. 13, 2004.
(60) Provisional application No. 60/656,345, filed on Feb. 25, 2005.

(51) Int. Cl. H04Q 7/00

(52) U.S. Cl. 370/389; 370/328; 370/394

(57) ABSTRACT

A system and method for supporting real-time services in a wireless network that uses ARQ. The system provides for discarding a packet before all the prescribed subpackets have been transmitted, and transmitting the next packet.

### CROSS-REFERENCE TO RELATED APPLICATIONS AND CLAIM OF PRIORITY

The present invention is related to that disclosed in U.S. Provisional Patent No. 60/587,620, filed Jul. 13, 2004, entitled “Support of Real-Time Services on the DO-A Systems” and U.S. Provisional Patent No. 60/656,345, filed Feb. 25, 2005, entitled “Support of Real-Time Services on the DO-A Systems”. U.S. Provisional Patent Nos. 60/587,620 and 60/656,345 are assigned to the assignee of the present application. The subject matter disclosed in U.S. Provisional Patent Nos. 60/587,620 and 60/656,345 is hereby incorporated by reference into the present disclosure as if fully set forth herein. The present application hereby claims priority under 35 U.S.C. §119(e) to U.S. Provisional Patent Nos. 60/587,620 and 60/656,345.

### TECHNICAL FIELD OF THE INVENTION

The present invention relates generally to wireless networks and, more specifically, to a technique for supporting real-time services such as voice-over-IP (VoIP) in a wireless network.

### BACKGROUND OF THE INVENTION

Wireless telecommunications have advanced from a network of analog carriers to large digital networks using many different standards. Some standards are designed as both data and voice carriers, while others are primarily designed as data-only carriers, such as the Evolution Data-Only (EV-DO) standard.

The 1xEV-DO Revision A Standard (CDMA2000 High Rate Packet Data Air Interface Specification, 3GPP2 C.S0024-A, Version 1.0, March 2004, by the “3rd Generation Partnership Project 2”, hereby incorporated by reference) defines an entity called the Access Terminal (AT) that is more commonly called a Mobile Station (MS) in a wireless communication system, and an entity called the Access Network (AN) that is more commonly called a Base Station (BS). In preparation for transmitting on the Forward Traffic Channel, the AN takes a Physical Layer packet of one of several standard sizes in bits, modulates it into a symbol sequence, and then applies repetition and puncturing, as appropriate, to generate a modulated packet.

The AN then transmits a portion, or subpacket, of the modulated packet in a 1.67-millisecond slot. If the AT receives the subpacket with few enough symbol errors, it can demodulate and reconstruct the original Physical Layer packet without bit errors, in which case it sends an ACK back to the AN during the third slot after the subpacket transmission. If the AT cannot reconstruct the original packet correctly, it sends a NAK. If the AN does not receive an ACK, it transmits the next portion, or subpacket, of the modulated packet four slots after it transmitted the first subpacket.

The AT then tries to reconstruct the original packet without bit errors using both of the subpackets it has received. If it still cannot reconstruct the original packet correctly, it sends another NAK. By example in the standard, the AN continues to transmit subpackets four slots apart until it receives an ACK from the AT. If the AT can reconstruct the original packet without bit errors, in which case it sends an ACK back to the AN, before the AN has transmitted all the subpackets, this is called early termination. However, by example in the standard, if the AN never receives an ACK from the AT, it transmits all the subpackets that make up the modulated packet symbol sequence. This maximum number of subpackets is called the Nominal Transmit Duration, or Span, and is one of the attributes of the Transmission Format.

Another attribute is the original Physical Layer packet length in bits. The final attribute is the preamble length in chips. A preamble identifying which AT the packet is intended for is prepended to the first subpacket of each packet transmitted.

There are a total of 33 Transmission Formats (i.e., combinations of these three attributes) for the Forward Traffic Channel with the Enhanced Forward Traffic Channel MAC Protocol. They are grouped by what is called Data Rate Control (DRC) Index, one to four formats per DRC Index (for Single User use). The AT selects the DRC Index value according to the nominal data rate it estimates can currently be supported on the Forward Traffic Channel, and sends this estimate to the AN every slot. The AN then selects one of the up to four Transmission Formats associated with that DRC Index. In each group, the Span is the same for all the formats.

The preamble length is also the same for all formats. It is the packet length that distinguishes the formats in a group; the AT does what is called “blind reception” or “rate matching” to determine the original packet length.

A significant disadvantage of this approach stems from the example procedure to transmit the entire Span of subpackets when the AT is unable to reconstruct the original packet correctly, coupled with the large Span sizes associated with small DRC Indexes. This adversely affects the performance of real-time applications, such as XoIP, including but not limited to Voice-over-IP.

Therefore, there is a need in the art for an improved system and method for high-rate wireless packet transmission that is suitable for XoIP transmissions.

### SUMMARY OF THE INVENTION

To address the above-discussed deficiencies of the prior art, it is an object of the present invention to provide, for use in a wireless network, a mobile station capable of packet data communications, said mobile station comprising a circuit for receiving radio-frequency signals, including packet data communications, wherein the packet data communications includes a series of packets, at least some of which have a first subpacket and a plurality of subsequent subpackets; and a processor, connected to decode the packet data communications, wherein the processor is configured to examine each received subpacket to determine if the received subpacket includes preamble data, wherein if one of the subsequent subpackets of a received packet includes preamble data, then that subpacket is identified as the first subpacket of a new packet, and all other subpackets of the received packet are discarded.

It is another object of the present invention to provide, for use in a wireless network, a mobile station capable of packet data communications, said mobile station comprising a circuit for receiving radio-frequency signals, including packet data communications, wherein the packet data communications includes a series of packets, at least some packets having a first subpacket and a plurality of subsequent subpackets; and a processor, connected to decode the packet data communications, wherein the processor is configured to detect a last subpacket identifier, wherein if a last subpacket identifier is detected, then the next subpacket received is determined to be the first subpacket of a new packet.

It is another object of the present invention to provide, for use in a wireless network, a base station capable of packet data communications, said base station comprising a circuit for transmitting radio-frequency signals, including packet data communications, wherein the packet data communications includes a series of packets, at least some packets having a first subpacket and a plurality of subsequent subpackets; a circuit for receiving radio-frequency signals, including acknowledgements indicating that a transmitted packet has been successfully received and decoded, and including negative acknowledgements indicating that a transmitted packet has not been successfully received and decoded; and a processor, connected to encode and decode the packet data communications, wherein if multiple subpackets of a first packet have been sent without receiving a corresponding acknowledgement, then the base station is configured to discard the first packet and send the first subpacket of a second packet.

It is another object of the present invention to provide, for use in a wireless network, a base station capable of packet data communications, said base station comprising a circuit for transmitting radio-frequency signals, including packet data communications, wherein the packet data communications includes a series of packets, at least some packets having a first subpacket and a plurality of subsequent subpackets; a circuit for receiving radio-frequency signals, including acknowledgements indicating that a transmitted packet has been successfully received and decoded, and including negative acknowledgements indicating that a transmitted packet has not been successfully received and decoded; and a processor, connected to encode and decode the packet data communications, wherein if multiple subpackets of a first packet have been sent without receiving a corresponding acknowledgement, then the base station is configured the first send a subpacket including a last subpacket identifier and thereafter send the first subpacket of a second packet.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention and its advantages, reference is now made to the following description taken in conjunction with the accompanying drawings, in which like reference numerals represent like parts:

FIG. 1 illustrates an exemplary wireless network that supports real-time services, such as voice-over-IP (VoIP), according to the principles of the present invention;

FIG. 2 illustrates an exemplary base station according to an exemplary embodiment of the present invention;

FIG. 3 illustrates wireless mobile station according to an advantageous embodiment of the present invention;

FIGS. 4A and 4B depict active and idle slots in accordance with an exemplary embodiment of the present invention; and

FIG. 5 depicts and active slot in accordance with an alternate embodiment of the present invention.

### DETAILED DESCRIPTION OF THE INVENTION

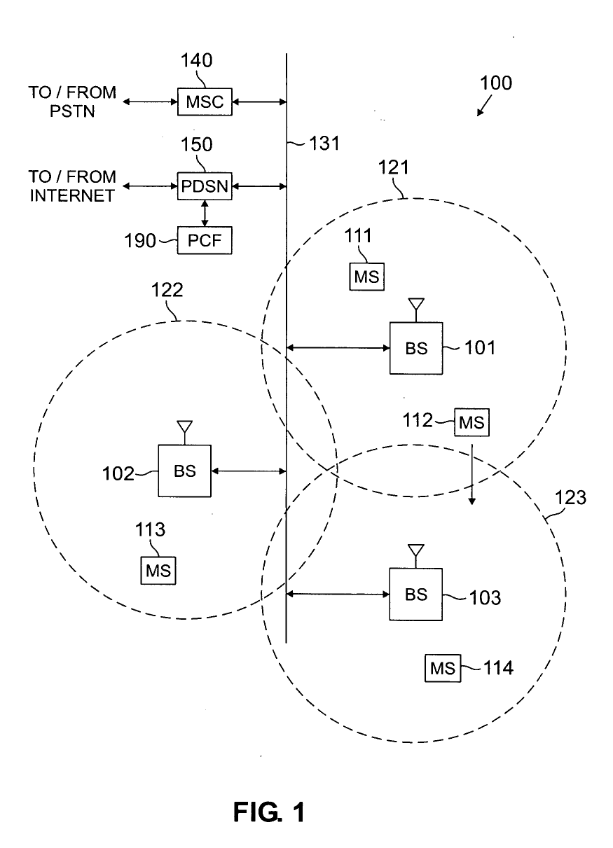

FIGS. 1 through 5, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged wireless network.

Preferred embodiments include techniques to support real time services, in particular Voice Over IP (VoIP), on the DO-A systems. Current DO-A systems are designed for non-real time applications. The systems are geared towards supporting higher data rates, higher latency applications.

Some of the issues addressed herein for supporting real time applications include (1) support of additional single user and multi-user transmission formats, and of a Span that is not limited to 1,2,4,8, 16, but can also support 3, 5, 7, 9, etc., (2) as an alternate embodiment, change in the MAC transmission format to transmit a last subpacket identifier.

Another issue is a better QoS guarantee. Different embodiments allow for support of different classes of QoS, dependent on the types of services. Another issue is a technique to increase the success of the transmission of packets, useful for boosted power applications.

The disclosed embodiments also enable an improved DO-A scheduler that helps to balance different QoS, such that VoIP (low delay, higher QoS) gets higher priority over NRT applications and such that NRT does not suffer too much and the overall throughput does not decrease. This also allows optimization of pre-scheduled, guaranteed users.

While the 1xEV-DO Revision A Standard uses the terms Access Terminal (AT) and Access Network (AN), the description herein will use the more common terms Mobile Station (MS) and Base Station (BS), as the techniques disclosed herein are not limited to systems complying with the 1xEV-DO Revision A Standard.

FIG. 1 illustrates exemplary wireless network 100, which supports real-time services, such as voice-over-IP (VoIP), according to the principles of the present invention. Wireless network 100 comprises a plurality of cell sites 121-123, each containing one of the base stations, BS 101, BS 102, or BS 103. Base stations 101-103 communicate with a plurality of mobile stations (MS) 111-114 over code division multiple access (CDMA) channels according to, for example, the IS-2000 standard (i.e., CDMA2000). In an advantageous embodiment of the present invention, mobile stations 111-114 are capable of receiving data traffic and/or voice traffic on two or more CDMA channels simultaneously. Mobile stations 111-114 may be any suitable wireless devices (e.g., conventional cell phones, PCS handsets, personal digital assistant (PDA) handsets, portable computers, telemetry devices) that are capable of communicating with base stations 101-103 via wireless links.

The present invention is not limited to mobile devices. The present invention also encompasses other types of wireless access terminals, including fixed wireless terminals. For the sake of simplicity, only mobile stations are shown and discussed hereafter. However, it should be understood that the use of the term “mobile station” in the claims and in the description below is intended to encompass both truly mobile devices (e.g., cell phones, wireless laptops) and stationary wireless terminals (e.g., a machine monitor with wireless capability).

Dotted lines show the approximate boundaries of cell sites 121-123 in which base stations 101-103 are located. The cell sites are shown approximately circular for the purposes of illustration and explanation only. It should be clearly understood that the cell sites may have other irregular shapes, depending on the cell configuration selected and natural and man-made obstructions.

As is well known in the art, each of cell sites 121-123 is comprised of a plurality of sectors, where a directional antenna coupled to the base station illuminates each sector. The embodiment of FIG. 1 illustrates the base station in the center of the cell. Alternate embodiments may position the directional antennas in corners of the sectors. The system of the present invention is not limited to any particular cell site configuration.

In one embodiment of the present invention, each of BS 101, BS 102 and BS 103 comprises a base station controller (BSC) and one or more base transceiver subsystem(s) (BTS). Base station controllers and base transceiver subsystems are well known to those skilled in the art. A base station controller is a device that manages wireless communications resources, including the base transceiver subsystems, for specified cells within a wireless communications network. A base transceiver subsystem comprises the RF transceivers, antennas, and other electrical equipment located in each cell site. This equipment may include air conditioning units, heating units, electrical supplies, telephone line interfaces and RF transmitters and RF receivers. For the purpose of simplicity and clarity in explaining the operation of the present invention, the base transceiver subsystems in each of cells 121, 122 and 123 and the base station controller associated with each base transceiver subsystem are collectively represented by BS 101, BS 102 and BS 103, respectively.

BS 101, BS 102 and BS 103 transfer voice and data signals between each other and the public switched telephone network (PSTN) (not shown) via communication line 131 and mobile switching center (MSC) 140. BS 101, BS 102 and BS 103 also transfer data signals, such as packet data, with the Internet (not shown) via communication line 131 and packet data server node (PDSN) 150. Packet control function (PCF) unit 190 controls the flow of data packets between base stations 101-103 and PDSN 150. PCF unit 190 may be implemented as part of PDSN 150, as part of MSC 140, or as a stand-alone device that communicates with PDSN 150, as shown in FIG. 1. Line 131 also provides the connection path for control signals transmitted between MSC 140 and BS 101, BS 102 and BS 103 that establish connections for voice and data circuits between MSC 140 and BS 101, BS 102 and BS 103.

Communication line 131 may be any suitable connection means, including a T1 line, a T3 line, a fiber optic link, a network packet data backbone connection, or any other type of data connection. Line 131 links each vocoder in the BSC with switch elements in MSC 140. The connections on line 131 may transmit analog voice signals or digital voice signals in pulse code modulated (PCM) format, Internet Protocol (IP) format, asynchronous transfer mode (ATM) format, or the like.

MSC 140 is a switching device that provides services and coordination between the subscribers in a wireless network and external networks, such as the PSTN or Internet. MSC 140 is well known to those skilled in the art. In some embodiments of the present invention, communications line 131 may be several different data links where each data link couples one of BS 101, BS 102, or BS 103 to MSC 140.

In the exemplary wireless network 100, MS 111 is located in cell site 121 and is in communication with BS 101. MS 113 is located in cell site 122 and is in communication with BS 102. MS 114 is located in cell site 123 and is in communication with BS 103. MS 112 is also located close to the edge of cell site 123 and is moving in the direction of cell site 123, as indicated by the direction arrow proximate MS 112. At some point, as MS 112 moves into cell site 123 and out of cell site 121, a hand-off will occur.

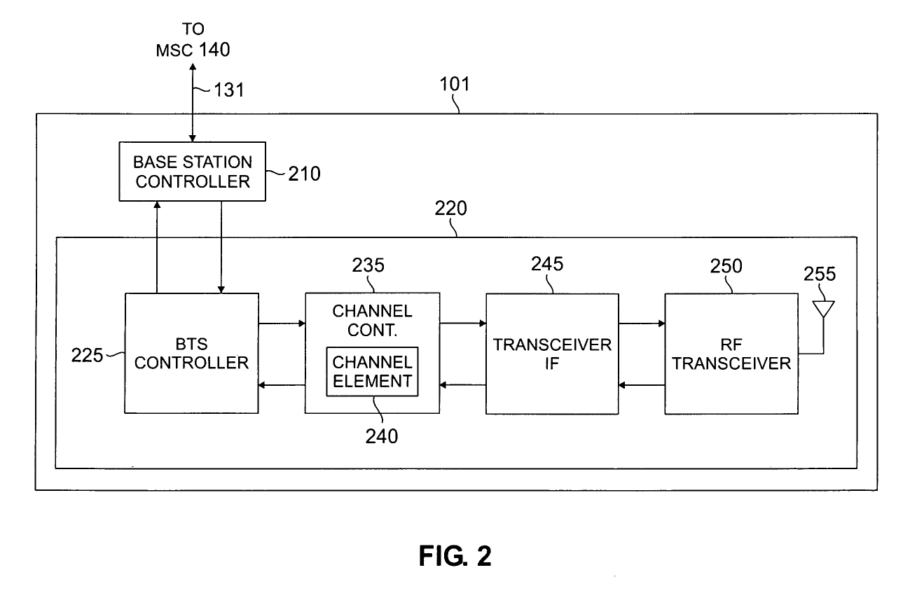

FIG. 2 illustrates exemplary base station 101 in greater detail according to an exemplary embodiment of the present invention. Base station 101 comprises base station controller (BSC) 210 and base transceiver station (BTS) 220. Base station controllers and base transceiver stations were described previously in connection with FIG. 1. BSC 210 manages the resources in cell site 121, including BTS 220. BTS 120 comprises BTS controller 225, channel controller 235 (which contains representative channel element 240), transceiver interface (IF) 245, RF transceiver 250, and antenna array 255.

In a preferred embodiment, base station 101 operates according to the 1xEV-DO Revision A Standard, as modified according to the teachings herein. Those of skill in the art will recognize that other wireless standards and protocols can be used by base station 101, similarly modified according to the teachings herein.

BTS controller 225 comprises processing circuitry and memory capable of executing an operating program that controls the overall operation of BTS 220 and communicates with BSC 210. Under normal conditions, BTS controller 225 directs the operation of channel controller 235, which contains a number of channel elements, including channel element 240, that perform bi-directional communications in the forward channel and the reverse channel. A “forward” channel refers to outbound signals from the base station to the mobile station and a “reverse” channel refers to inbound signals from the mobile station to the base station. Transceiver IF 245 transfers the bi-directional channel signals between channel controller 240 and RF transceiver 250.

According to various embodiments, either BTS controller 225 or channel controller 235 is configured to transmit subpackets on a forward channel, as described herein, and receive ACK or NAK signals from mobile stations in response. Further, in various embodiments, either BTS controller 225 or channel controller 235 is configured to transmit last subpacket identifiers, described below, to indicate when the last subpacket of a current packet has been sent.

Antenna array 255 transmits forward channel signals received from RF transceiver 250 to mobile stations in the coverage area of BS 101. Antenna array 255 also sends to RF transceiver 250 reverse channel signals received from mobile stations in the coverage area of BS 101. In a preferred embodiment of the present invention, antenna array 255 is multi-sector antenna, such as a three-sector antenna in which each antenna sector is responsible for transmitting and receiving in a 120° arc of coverage area. Additionally, RF transceiver 250 may contain an antenna selection unit to select among different antennas in antenna array 255 during both transmit and receive operations.

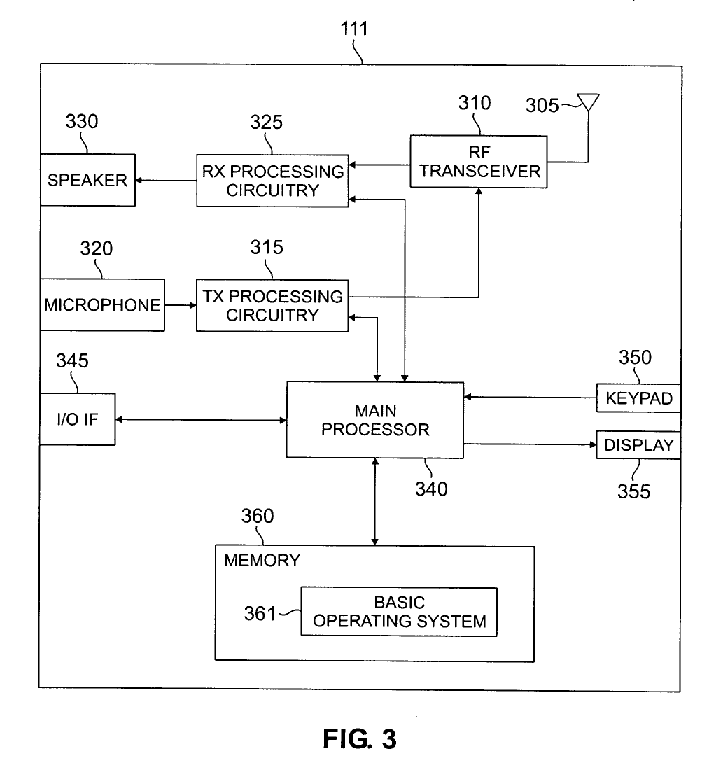

FIG. 3 illustrates wireless mobile station 111 according to an advantageous embodiment of the present invention. Wireless mobile station 111 comprises antenna 305, radio frequency (RF) transceiver 310, transmit (TX) processing circuitry 315, microphone 320, and receive (RX) processing circuitry 325. MS 111 also comprises speaker 330, main processor 340, input/output (I/O) interface (IF) 345, keypad 350, display 355, and memory 360. Memory 360 further comprises basic operating system (OS) program 361.

In a preferred embodiment, wireless mobile station 111 operates according to the 1xEV-DO Revision A Standard, as modified according to the teachings herein. Those of skill in the art will recognize that other wireless standards and protocols can be used by wireless mobile station 111, similarly modified according to the teachings herein.

Radio frequency (RF) transceiver 310 receives from antenna 305 an incoming RF signal transmitted by a base station of wireless network 100. Radio frequency (RF) transceiver 310 down-converts the incoming RF signal to produce an intermediate frequency (IF) or a baseband signal. The IF or baseband signal is sent to receiver (RX) processing circuitry 325 that produces a processed baseband signal by filtering, decoding, and/or digitizing the baseband or IF signal. Receiver (RX) processing circuitry 325 transmits the processed baseband signal to speaker 330 (i.e., voice data) or to main processor 340 for further processing (e.g., web browsing).

Transmitter (TX) processing circuitry 315 receives analog or digital voice data from microphone 320 or other outgoing baseband data (e.g., web data, e-mail, interactive video game data) from main processor 340. Transmitter (TX) processing circuitry 315 encodes, multiplexes, and/or digitizes the outgoing baseband data to produce a processed baseband or IF signal. Radio frequency (RF) transceiver 310 receives the outgoing processed baseband or IF signal from transmitter (TX) processing circuitry 315. Radio frequency (RF) transceiver 310 up-converts the baseband or IF signal to a radio frequency (RF) signal that is transmitted via antenna 305.

In an advantageous embodiment of the present invention, main processor 340 is a microprocessor or microcontroller. Memory 360 is coupled to main processor 340. According to an advantageous embodiment of the present invention, part of memory 360 comprises a random access memory (RAM) and another part of memory 360 comprises a Flash memory, which acts as a read-only memory (ROM).

Main processor 340 executes basic operating system (OS) program 361 stored in memory 360 in order to control the overall operation of wireless mobile station 111. In one such operation, main processor 340 controls the reception of forward channel signals and the transmission of reverse channel signals by radio frequency (RF) transceiver 310, receiver (RX) processing circuitry 325, and transmitter (TX) processing circuitry 315, in accordance with well-known principles.

Main processor 340 is capable of executing other processes and programs resident in memory 360. Main processor 340 can move data into or out of memory 360, as required by an executing process. Main processor 340 is also coupled to I/O interface 345. I/O interface 345 provides mobile station 111 with the ability to connect to other devices such as laptop computers and handheld computers. I/O interface 345 is the communication path between these accessories and main controller 340.

Main processor 340 is also coupled to keypad 350 and display unit 355. The operator of mobile station 111 uses keypad 350 to enter data into mobile station 111. Display 355 may be a liquid crystal display capable of rendering text and/or at least limited graphics from web sites. Alternate embodiments may use other types of displays.

In a preferred embodiment, main processor 340 is configured to process received data packets according to 1xEV-DO Revision A Standard, known to those of skill in the art, modified as described herein.

In a preferred embodiment, main processor 340 is also configured to identify a preamble if present in any slot of a received data packet, indicating that the MS is receiving a first subpacket of a new packet intended for that MS, as described below. Further, in some embodiments, main processor 340 is also configured to identify a last subpacket identifier, when received.

A significant disadvantage of known approaches, as described above, stems from the example procedure to transmit the entire Span of subpackets when the MS is unable to reconstruct the original packet correctly, coupled with the large Span sizes associated with small DRC Indexes.

Since the subpacket transmissions are separated by 4 slots, the maximum inter-packet transmission interval—the time from when the first subpacket of one packet is transmitted until the first subpacket of the next packet can be transmitted—equals the Span (subpackets per packet)×4 slots per inter-subpacket interval×1.67 ms per slot. For the DRC Indexes 0x1, 0x2, and 0x3 (& 0x5), the Spans are 16, 8, and 4, respectively, making the maximum inter-packet interval 106.67, 53.33, and 26.67 milliseconds, respectively. For some real-time, Quality of Service (QoS) applications such as Voice over IP (VoIP) or other XoIP application that have a stringent latency requirement and/or a high packet offered rate, one or both of these inter-packet intervals may be too long.

Furthermore, one out of every four slots—25% of the transmit resources—are used up for the entire time that a packet is waiting for an ACK, using up valuable transmit capacity. In other words, it may be better for the BS to give up transmitting subpackets after, say, 8 or fewer subpackets (53.33 ms or less), or even after only two sub packets (13.33 ms), even if the MS has been unable to reconstruct the original packet correctly, in order to transmit the next packet in the sequence. If the packet is going to arrive at the endpoint too late and would get discarded anyhow, it is better to discard it as soon as possible to free up resources.

A preferred embodiment therefore provides for the BS to stop transmitting subpackets of the current packet on the DO-A Forward Traffic Channel before having received an ACK from the MS, in situations that warrant not waiting for the entire Span (maximum number) of subpackets to be transmitted.

This “forced early termination” will allow the BS to go ahead and transmit the first subpacket of a new packet in the slot that otherwise a subpacket of the current packet would have occupied. The new packet can be for the MS for which the current packet was intended or another MS.

Preferably, every MS—including the MS for which the current packet was intended—must be looking for a preamble, indicating this is the first subpacket of a new packet intended for that MS, in every slot—even the slots that normally would contain subpackets subsequent to the first subpacket of the current packet. The MSs other than the MS for which the current packet was intended must already be following this procedure (looking for a preamble), because they are unaware of the Span of the packet whose subpacket is currently being transmitted.

Preferably, the MS that is currently receiving subpackets of a packet must look for not only the next subpacket of that packet but also a preamble in the first subpacket of a new packet.

The forced early termination technique described herein gives the BS flexibility to handle real-time, QoS applications better, and also to handle more of them. It can reduce the latency without increasing the packet loss rate, and/or it can increase the number of concurrently active MSs without increasing the latency and packet loss rate.

Alternate embodiments include a dynamic algorithm for forced early termination. In other words, do not early-terminate in some situations, and early-terminate after greater or less than 8 transmissions, depending on the situation. For example, the more packets queued for an MS, the fewer transmissions of the current packet before forced early termination. Or, the more the congestion in general, the fewer transmissions per packet. A dynamic algorithm can also favor higher priority users over others (even those that would have to perform retransmissions at a higher protocol layer) in the face of congestion.

The techniques disclosed herein can be applied to not only evolution data-only (e.g., EV-DO-A) systems but also other systems, including but not limited to hybrid ARQ systems such as evolution data and voice (EV-DV).

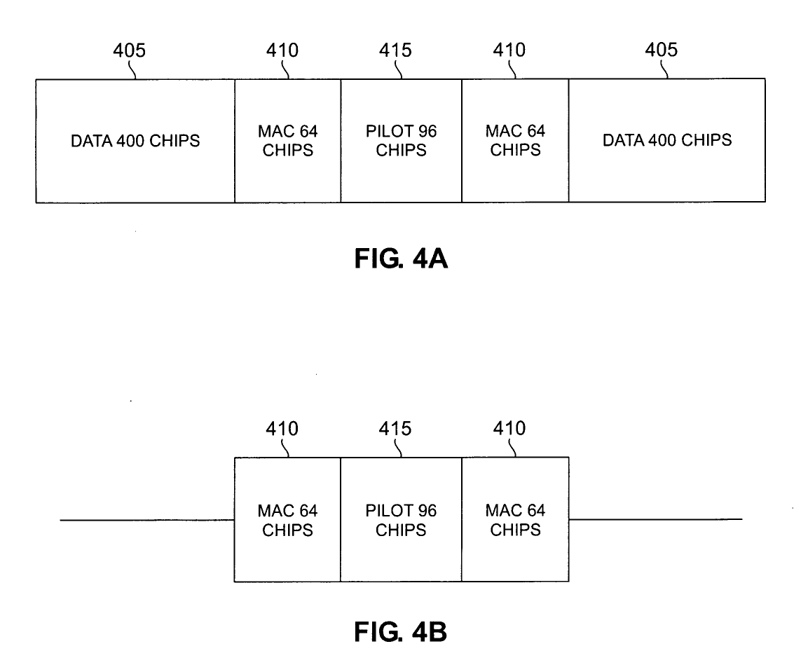

Some embodiments described above are implemented using active and idle slots on the forward channel, as illustrated in FIGS. 4A and 4B.

FIG. 4A depicts an active slot in accordance with this embodiment, including data slot 405, MAC slot 410, and pilot slot 415. This Figure shows 1024 chips, which generally corresponds to one-half a full active slot.

FIG. 4B depicts an idle slot in accordance with a preferred embodiment, including MAC slot 415 and pilot slot 420.

Another alternative embodiment includes the BS transmitting an explicit “last subpacket identifier”. For example, a few (e.g., 1 or 4 or 16) chips can be taken from each of the 4 400-chip data segments of the Forward Link slot to explicitly tell the MS that this is the last subpacket of the current packet that the BS is going to transmit, even if the MS is still unable to reconstruct the packet after processing this subpacket. This eliminates the requirement for the MS to look for a preamble in slots in which it was expecting subsequent subpackets of the current packet.

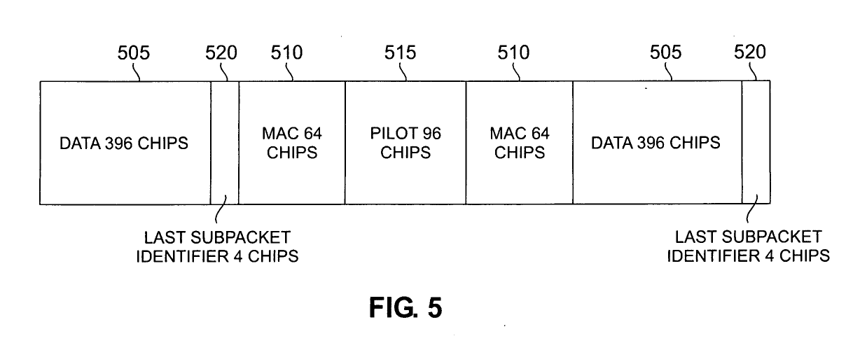

The alternate embodiment adds a last subpacket identifier to the Forward Link Slot Structure, as shown in FIG. 5. A system in accordance with this alternate embodiment takes 4 chips from each of the 4 400-chip data segments of the Forward Link slot, as shown in FIG. 5. This takes 4 chips per segment×4 segments per slot/16 chips per symbol=1 whole symbol per slot from each of the 16 demultiplexed symbol streams. If the base station sets the value equal to ‘1’, the mobile terminal can determine that the received sub packet is the last sub packet.

FIG. 5 depicts an active slot in accordance with this embodiment, including data slot 505, MAC slot 510, and pilot slot 515. Last subpacket identifier slot 520 indicates whether there is a packet following this sub-packet for this particular mobile station. This Figure shows 1024 chips, which generally corresponds to one-half a full active slot.

An idle slot, in accordance with this alternate embodiment, is the same as the typical idle slot show in FIG. 4B.

In some embodiments, to guarantee reliable delivery, the last sub-packet identifiers are transmitted with power boosting. This ensures that the access terminals receive the packets.

According to a preferred embodiment, to ensure the guaranteed reception of the last sub packet identifier, a factor of 4 redundancy is used. All four last subpacket identifiers carry the same information. The mobile station, once it receives the information, performs the OR operation of the last sub-packet identifiers to determine whether there is a sub-packet following the current sub-packet.

As can be seen from Table 1 and Table 2, below, the maximum number of slots required to transmit the data in the current DO-A systems are fixed. Except for 1-slot transmissions, the maximum number of slots to be used has to be multiples of 2. This tends to cause the scheduling of the DO—systems to be more rigid. Hence, if the resources are available for a non-even slot, the base station still can't schedule that particular user. For supporting lower data rates, the number of slots required to transmit the data ranges from 4 to 16. All this contributes to the latency in the systems.

TABLE 1

| TRANSMISSION FORMAT | | | |
|---|---|---|---|
| (Physical Layer Packet Size (bits), | | | |
| Nominal Transmit Duration (slots), | Pilot | MAC | DATA |
| Preamble Length (chips)) | Chips | Chips | Chips |
| (128, 16, 1,024) | 3,072 | 4,096 | 24,576 |
| (128, 8, 512) | 1,536 | 2,048 | 12,288 |
| (128, 4, 1024) | 768 | 1,024 | 5,376 |
| (128, 4, 256) | 768 | 1,024 | 6,144 |
| (128, 2, 128) | 384 | 512 | 3,072 |
| (128, 1, 64) | 192 | 256 | 1,536 |
| (256, 16, 1024) | 3,072 | 4,096 | 24,576 |
| (256, 8, 512) | 1,536 | 2,048 | 12,288 |
| (256, 4, 1024) | 768 | 1,024 | 5,376 |
| (256, 4, 256) | 768 | 1,024 | 6,144 |
| (256, 2, 128) | 384 | 512 | 3,072 |
| (256, 1, 64) | 192 | 256 | 1,536 |
| (512, 16, 1024) | 3,072 | 4,096 | 24,576 |
| (512, 8, 512) | 1,536 | 2,048 | 12,288 |
| (512, 4, 1024) | 768 | 1,024 | 5,376 |
| (512, 4, 256) | 768 | 1,024 | 6,144 |
| (512, 4, 128) | 768 | 1,024 | 6,272 |
| (512, 2, 128) | 384 | 512 | 3,072 |
| (512, 2, 64) | 384 | 512 | 3,136 |
| (512, 1, 64) | 192 | 256 | 1,536 |
| (1024, 16, 1024) | 3,072 | 4,096 | 24,576 |
| (1024, 8, 512) | 1,536 | 2,048 | 12,288 |
| (1024, 4, 256) | 768 | 1,024 | 6,144 |
| (1024, 4, 128) | 768 | 1,024 | 6,272 |
| (1024, 2, 128) | 384 | 512 | 3,072 |
| (1024, 2, 64) | 384 | 512 | 3,136 |
| (1024, 1, 64) | 192 | 256 | 1,536 |
| (2048, 4, 128) | 768 | 1,024 | 3,072 |
| (2048, 2, 64) | 384 | 512 | 3,136 |
| (2048, 1, 64) | 192 | 256 | 1,536 |
| (3072, 2, 64) | 384 | 512 | 3,136 |
| (3072, 1, 64) | 192 | 256 | 1,536 |
| (4096, 2, 64) | 384 | 512 | 3,136 |
| (4096, 1, 64) | 192 | 256 | 1,536 |
| (5120, 2, 64) | 384 | 512 | 3,136 |
| (5120, 1, 64) | 192 | 256 | 1,536 |

TABLE 2

| | Number of Values Per Physical Layer Packet | | | | |
|---|---|---|---|---|---|
| | | | | | TDM Chips |
| Data | | | | | (Preamble, |
| Rate | | | Code | Modulation | Pilot, |
| (kbps) | Slots | Bits | Rate | Type | Mac, Data) |
| 38.4 | 16 | 1,024 | 1/5 | QPSK | 1,024 |
| | | | | | 3,072 |
| | | | | | 4,096 |
| | | | | | 24,576 |
| 76.8 | 8 | 1,024 | 1/5 | QPSK | 512 |
| | | | | | 1,536 |
| | | | | | 2,048 |
| | | | | | 12,288 |
| 153.6 | 4 | 1,024 | 1/5 | QPSK | 256 |
| | | | | | 768 |
| | | | | | 1,024 |
| | | | | | 6,144 |
| 307.2 | 2 | 1,024 | 1/5 | QPSK | 128 |
| | | | | | 384 |
| | | | | | 512 |
| | | | | | 3,072 |
| 614.4 | 1 | 1,024 | 1/3 | QPSK | 64 |
| | | | | | 192 |
| | | | | | 256 |
| | | | | | 1,536 |
| 307.2 | 4 | 2,048 | 1/3 | QPSK | 128 |
| | | | | | 768 |
| | | | | | 1,024 |
| | | | | | 6,272 |
| 614.4 | 2 | 2,048 | 1/3 | QPSK | 64 |
| | | | | | 384 |
| | | | | | 512 |
| | | | | | 3,136 |
| 1,228.8 | 1 | 2,048 | 1/3 | QPSK | 64 |
| | | | | | 192 |
| | | | | | 256 |
| | | | | | 1,536 |
| 921.6 | 2 | 3,072 | 1/3 | 8-PSK | 64 |
| | | | | | 384 |
| | | | | | 512 |
| | | | | | 3,136 |
| 1,843.2 | 1 | 3,072 | 1/3 | 8-PSK | 64 |
| | | | | | 192 |
| | | | | | 256 |
| | | | | | 1,536 |
| 1,228.8 | 2 | 4,096 | 1/3 | 16-QAM | 64 |
| | | | | | 384 |
| | | | | | 512 |
| | | | | | 3,136 |
| 2457.6 | 1 | 4,096 | 1/3 | 16-QAM | 64 |
| | | | | | 192 |
| | | | | | 256 |
| | | | | | 1,536 |

For lower DRCs, as per the current standards, the delay for transmitting the packets becomes very large, because of Span. In the preferred embodiments, however, since the reconstruction and transmission of the packets are independent of the Span mechanism, the delay is considerably reduced. The base station can schedule the user every other slot for faster delivery for applications like VoIP and thus reduce the latency considerably. Thus, the scheduling of the DO-A systems gets improved resulting in faster delivery of the packets.

For the DRC Indexes 0x1, 0x2, and 0x3 (& 0x5), the Spans are 16, 8, and 4, respectively, making the maximum inter-packet interval 106.67, 53.33, and 26.67 milliseconds, respectively. For some Quality of Service applications such as Voice over IP (VoIP) that have a high packet offered rate, one or all of these inter-packet intervals may be too long. In other words, it may be better for the BS to give up transmitting sub packets after, say, only two sub packets (13.33 ms), even if the MS has been unable to reconstruct the original packet correctly, in order to transmit the next packet in the sequence. The problem with the current standard is that it prescribes the BS to continue to transmit sub packets up to the specified Span, in the absence of receiving an ACK, and the AN must use the Span associated with the DRC Index (if the AT selected larger than warranted DRC Indexes, the packet error rate would increase unacceptably).

The reason for the OR operation is again to ensure that the mobile stations do not miss the packets intended for it.

According to a preferred embodiment, the base station can schedule the user anytime it wants, without having to wait for the even interval that the mobile station can receive the packets on. This gives freedom to the base station in scheduling the users and hence reduces the scheduling latency.

Further, since there is no need to transmit the packets only in their pre-designed fixed slots, the latency caused because of the Span is also reduced.

Preferably, the disclosed method mechanism of packet reconstruction can be turned ON or OFF, with the flag transmitted in the overhead messages.

According to an alternative embodiment, one chip is taken from each of the four 400-chip data segments of the Forward Link slot. This takes 1 chip per segment×4 segments per slot/16 chips per symbol=¼ symbol per slot from each of the 16 demultiplexed symbol streams in which the 16-ary Walsh Covers are added. This takes 1 chip per segment/400 total chips per segment=only ¼% of the payload data rate.

According to another alternative embodiment, 16 chips are taken from each of the 400-chip data segments of the Forward Link slot. This takes 16 chips per segment/16 chips per symbol=1 whole symbol from each 400-chip data segment of each of the 16 demultiplexed symbol streams, which is more acceptable from a design standpoint. However, it takes 16 chips per segment/400 total chips per segment=4% of the payload data rate.

Other alternative embodiments essentially add another channel to the Forward Link Structure. These would not take away any payload data rate. Another alternative embodiment includes expanding the 128-ary Walsh Cover for the MACindex to become 256-ary. This requires the current QPSK modulation to become 8PSK. Another alternative embodiment includes adding another channel input to the Walsh Chip Level Summer or to the TDM 3:1 combiner, in addition to the current MAC Channel P-ARQ and DRCLock bits.

Although the present invention has been described with an exemplary embodiment, various changes and modifications may be suggested to one skilled in the art. It is intended that the present invention encompass such changes and modifications as fall within the scope of the appended claims.

What is claimed is:

1. For use in a wireless network, a mobile station capable of packet data communications, said mobile station comprising:
a circuit for receiving radio-frequency signals, including packet data communications, wherein the packet data communications includes a series of packets, at least some packets having a first subpacket and a plurality of subsequent subpackets; and
a processor, connected to decode the packet data communications, wherein the processor is configured to examine each received subpacket to determine if the received subpacket includes preamble data,
wherein if one of the subsequent subpackets of a received packet includes preamble data, then that subpacket is identified as the first subpacket of a new packet, and all other subpackets of the received packet are discarded.

2. The mobile station as set forth in claim 1, wherein said mobile station is capable of communicating according to the 1xEV-DO Revision A Standard.

3. The mobile station as set forth in claim 1, wherein said mobile station is configured to send an acknowledgement after a subpacket has been received and the original packet has been successfully reconstructed.

4. The mobile station as set forth in claim 1, wherein said mobile station is configured to send a negative acknowledgement after a subpacket has been received and the original packet has not been successfully reconstructed.

5. The mobile station as set forth in claim 1, wherein each packet has eight subpackets.

6. For use in a wireless network, a mobile station capable of packet data communications, said mobile station comprising:
a circuit for receiving radio-frequency signals, including packet data communications, wherein the packet data communications includes a series of packets, at least some packets having a first subpacket and a plurality of subsequent subpackets; and
a processor, connected to decode the packet data communications, wherein the processor is configured to detect a last subpacket identifier,
wherein if a last subpacket identifier is detected, then the next subpacket received is determined to be the first subpacket of a new packet.

7. The mobile station as set forth in claim 6, wherein said mobile station is capable of communicating according to the 1xEV-DO Revision A Standard.

8. The mobile station as set forth in claim 6, wherein said mobile station is configured to send an acknowledgement after a subpacket has been received and the original packet has been successfully reconstructed.

9. The mobile station as set forth in claim 6, wherein said mobile station is configured to send a negative acknowledgement after a subpacket has been received and the original packet has not been successfully reconstructed.

10. The mobile station as set forth in claim 6, wherein each packet has eight subpackets.

11. The mobile station as set forth in claim 6, wherein the last subpacket identifier is detected in a data slot forward data channel received by the mobile station.

12. For use in a wireless network, a base station capable of packet data communications, said base station comprising:
a circuit for transmitting radio-frequency signals, including packet data communications, wherein the packet data communications includes a series of packets, at least some packets having a first subpacket and a plurality of subsequent subpackets;
a circuit for receiving radio-frequency signals, including acknowledgements indicating that a transmitted packet has been successfully received and decoded, and including negative acknowledgements indicating that a transmitted packet has not been successfully received and decoded; and
a processor, connected to encode and decode the packet data communications,
wherein if multiple subpackets of a first packet have been sent without receiving a corresponding acknowledgement, then the base station is configured to discard the first packet and send the first subpacket of a second packet.

13. The base station as set forth in claim 12, wherein said base station is capable of communicating according to the 1xEV-DO Revision A Standard.

14. The base station as set forth in claim 12, wherein each first subpacket includes a preamble identifying it as the first subpacket of a packet.

15. The base station as set forth in claim 12, wherein the multiple subpackets are at least half the total number of subpackets in the packet.

16. The base station as set forth in claim 12, wherein when the first packet is discarded, the base station transmits a last subpacket identifier.

17. The base station as set forth in claim 16, wherein the last subpacket identifier is transmitted in a data slot of a forward data channel transmitted by the base station.

18. The base station as set forth in claim 12, wherein the base station transmits VoIP communications over a data-only network.

19. The base station as set forth in claim 12, wherein each packet has at least eight subpackets.

20. The base station as set forth in claim 12, wherein if multiple subpackets of a first packet have been sent and multiple corresponding negative acknowledgements have been received, then the base station is configured to discard the first packet and send the first subpacket of a second packet.
